(19) United States
(12) Patent Application Publication
(10) Pub. No.: US 2024/0104459 A1
(43) Pub. Date: Mar. 28, 2024

(54) SYSTEMS, METHODS, AND APPARATUSES FOR IMPLEMENTING RESOURCE OWNERSHIP VERIFICATIONS IN A FEDERATED DISTRIBUTED LEDGER IN A DISTRIBUTED NETWORK

(71) Applicant: BANK OF AMERICA CORPORATION, Charlotte, NC (US)

(72) Inventors: Brady Prentice Merkel, Jacksonville Beach, FL (US); Mardochee Macxis, Concord, NC (US); Richard Huw Thomas, Charlotte, NC (US)

(73) Assignee: BANK OF AMERICA CORPORATION, Charlotte, NC (US)

(21) Appl. No.: 17/950,665

(22) Filed: Sep. 22, 2022

(51) Int. Cl. G06Q 10/06

(52) U.S. Cl. CPC G06Q 10/06313; G06Q 2220/18

(57) ABSTRACT

Systems, computer program products, and methods are described herein for implementing resource ownership verifications in a federated distributed ledger. The present invention is configured to receive a query, wherein the query comprises a resource identifier; identify a federated distributed ledger associated with the resource identifier, the federated distributed ledger comprising data associated with an ownership of a resource associated with the resource identifier; query at least one entity associated with the resource, the query of the at least one entity associated with the resource comprising an update request of the resource, wherein the update request comprises a request to the at least one entity associated with the resource to determine a current owner of the resource; and update the federated distributed ledger with the current owner of the resource.

### FIELD OF THE INVENTION

The present invention embraces a system for implementing resource ownership verifications in a federated distributed ledger in a distributed network.

### BACKGROUND

Consumers, owners, and/or individuals may have a difficult time proving ownership of their resources in a quick, secure, and efficient manner. For instance, and where the resource may be a physical piece of property that the owner may or may not be able carry with them at all times, such as a piece of paper, a card, a piece of real estate property, and/or the like. For instance, such resources may comprise certificates (such as identification cards, birth certificates, passports, and/or the like) or may comprise real estate or property (such as cars, real estate, and/or the like), which a user may have a difficult time verifying ownership in a secure manner and without undue hardship. This problem arises especially where an owner hoping to do business with a third party—such as an entity like a financial institution, merchant, company, and/or the like—may need to verify ownership in a secure manner and without the need for owner intervention, where the owner intervention needed to confirm ownership may slow down the ownership verification process. A need, therefore, exists for a system to verify ownership of a resource in an accurate, efficient and secure manner.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for implementing a resource ownership verification is provided. The system may comprise a memory device with computer-readable program code stored thereon; at least one processing device operatively coupled to the at least one memory device and the at least one communication device, wherein executing the computer-readable code is configured to cause the at least one processing device to: receive a query, wherein the query comprises a resource identifier; identify a federated distributed ledger associated with the resource identifier, the federated distributed ledger comprising data associated with an ownership of a resource associated with the resource identifier; query at least one entity associated with the resource, the query of the at least one entity associated with the resource comprising an update request of the resource, wherein the update request comprises a request to the at least one entity associated with the resource to determine a current owner of the resource; and update the federated distributed ledger with the current owner of the resource.

In some embodiments, the processing device is further configured to allow access of the federated distributed ledger to a user associated with the query comprising the resource identifier.

In some embodiments, the processing device is further configured to allow access of the federated distributed ledger to a plurality of pre-selected entities.

In some embodiments, the processing device is further configured to generate a verifiable resource token based on the federated distributed ledger, wherein the verifiable resource token comprises data of at least the resource and the current owner of the resource.

In some embodiments, the federated distributed ledger associated with the resource comprises data regarding a historical ownership of the resource.

In some embodiments, the resource is at least one of a government identification certificate or an owner certificate.

In some embodiments, the federated distributed ledger comprises data regarding a plurality of geolocations associated with the resource.

In some embodiments, the federated distributed ledger comprises data regarding a plurality of timestamps associated with the resource.

In some embodiments, the identification of the federated distributed ledger comprises querying a plurality of federated distributed ledgers based on the resource identifier.

In another aspect, a computer program product for implementing a resource ownership verification is provided. The computer program product may comprise at least one non-transitory computer-readable medium having computer-readable program code portions embodied therein, the computer-readable program code portions which when executed by a processing device are configured to cause the processor to: receive a query, wherein the query comprises a resource identifier; identify a federated distributed ledger associated with the resource identifier, the federated distributed ledger comprising data associated with an ownership of a resource associated with the resource identifier; query at least one entity associated with the resource, the query of the at least one entity associated with the resource comprising an update request of the resource, wherein the update request comprises a request to the at least one entity associated with the resource to determine a current owner of the resource; and update the federated distributed ledger with the current owner of the resource.

In some embodiments, the processing device processing device is further configured to cause the processor to generate a verifiable resource token based on the federated distributed ledger, wherein the verifiable resource token comprises data of at least the resource and the current owner of the resource.

In some embodiments, the identification of the federated distributed ledger comprises querying a plurality of federated distributed ledgers based on the resource identifier.

In some embodiments, the federated distributed ledger associated with the resource comprises data regarding a historical ownership of the resource.

In some embodiments, the federated distributed ledger comprises data regarding a plurality of geolocations associated with the resource.

In some embodiments, the federated distributed ledger comprises data regarding a plurality of timestamps associated with the resource.

In another aspect, a computer-implemented method for implementing a resource ownership verification is provided. The computer-implemented method may comprise: receiving a query, wherein the query comprises a resource identifier; identifying a federated distributed ledger associated with the resource identifier, the federated distributed ledger comprising data associated with an ownership of a resource associated with the resource identifier; querying at least one entity associated with the resource, the query of the at least one entity associated with the resource comprising an update request of the resource, wherein the update request comprises a request to the at least one entity associated with the resource to determine a current owner of the resource; and updating the federated distributed ledger with the current owner of the resource.

In some embodiments, the computer-implemented method may further comprise generating a verifiable resource token based on the federated distributed ledger, wherein the verifiable resource token comprises data of at least the resource and the current owner of the resource.

In some embodiments, the identification of the federated distributed ledger comprises querying a plurality of federated distributed ledgers based on the resource identifier.

In some embodiments, the federated distributed ledger comprises data regarding a plurality of geolocations associated with the resource.

In some embodiments, the federated distributed ledger comprises data regarding a plurality of timestamps associated with the resource.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for implementing resource ownership verifications in a federated distributed ledger in a distributed network, in accordance with an embodiment of the invention;

FIG. 2 illustrates a process flow for implementing resource ownership verifications in a federated distributed ledger in a distributed network, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository—a storage location where one or more resources are organized, stored and retrieved electronically using a computing device.

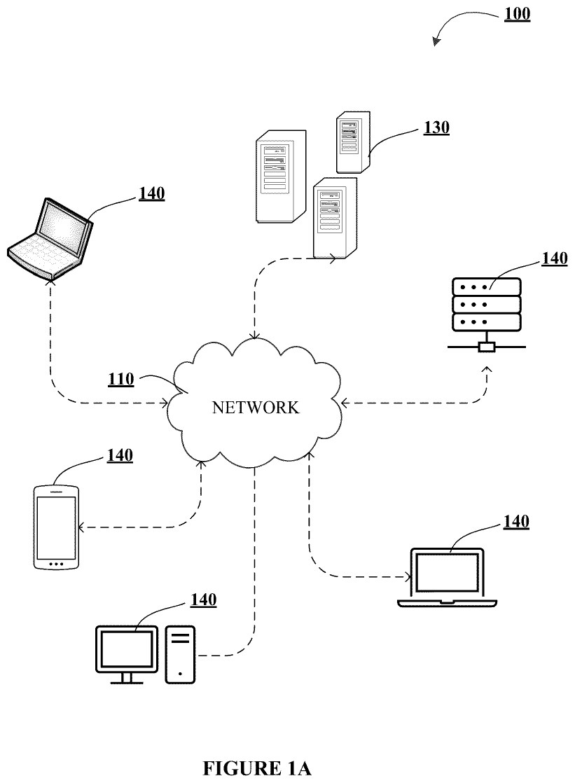

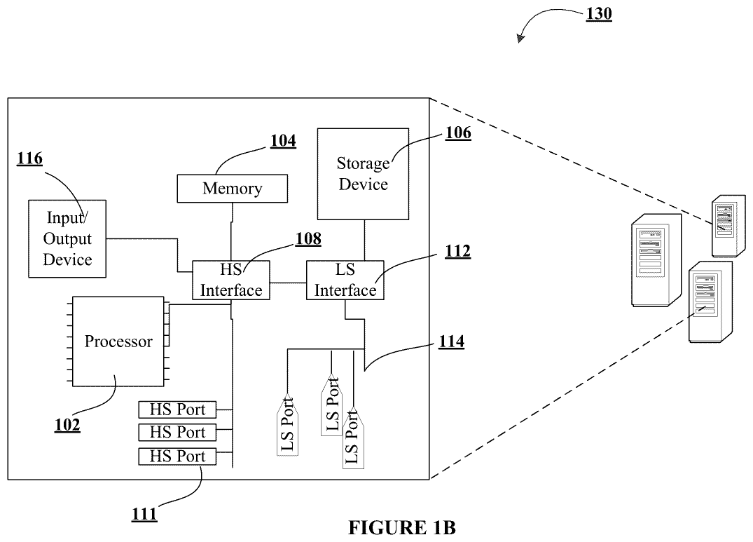

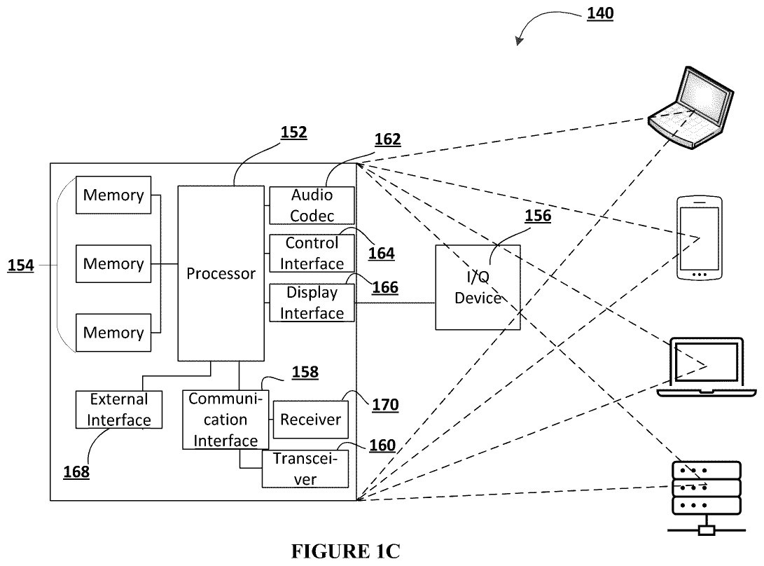

As described in further detail herein, the present invention provides a solution to the above-referenced problems in the field of technology by generating an accurate, efficient, and secure system for verifying resource ownership. Such a system (e.g., an ownership verification system) may offer a federated distributed ledger that can be separately verified by an entity associated with the resource, such as the entity that generated the resource (e.g., the government entity that generated the passport, the identification card/certificate, the birth certificate, the social security number, and/or the like; the financial institution that generated the ownership certificate, such as the mortgage certificate, the title certificate, and/or the like; and/or the like), without separate authorization by the current owner of the resource for ownership verification. The present invention solves the technical problem by implementing an ownership verification system, like that shown in FIGS. 1A-1C. For instance, the ownership verification system acts by identifying a federated distributed ledger based on a resource identifier associated with the resource, where the federated distributed ledger may comprise data associated with an ownership of the resource. The ownership verification system may further query an entity associated with the resource (e.g., financial institution that generated the resource, government entity that generated the resource, and/or the like) to request update data associated with the resource, such as an update of the current owner and/or other historical data, such that the ownership verification system may update the federated distributed ledger with the update data.

Accordingly, the present invention works by the ownership verification system receiving a query, wherein the query comprises a resource identifier; identifying a federated distributed ledger associated with the resource identifier, the federated distributed ledger comprising data associated with an ownership of a resource associated with the resource identifier. The ownership verification system may further query at least one entity associated with the resource, the query of the at least one entity associated with the resource comprising an update request of the resource, where the update request comprises a request to the at least one entity to determine at least the current owner of the resource. The ownership verification system may further update the federated distributed ledger with the current owner of the resource.

What is more, the present invention provides a technical solution to a technical problem. As described herein, the technical problem includes the inability of prior systems to accurately track and update a distributed ledger associated with a resource, where the distributed ledger is a federated distributed ledger and may be accessed by different entities (in real time). The technical solution presented herein allows for the accurate, efficient, and secure verification of resource ownership in a federated distributed ledger. In particular, the ownership verification system is an improvement over existing solutions to the resource ownership verification process, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

FIGS. 1A-1C illustrate technical components of an exemplary distributed computing environment for implementing resource ownership verifications in a federated distributed ledger 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

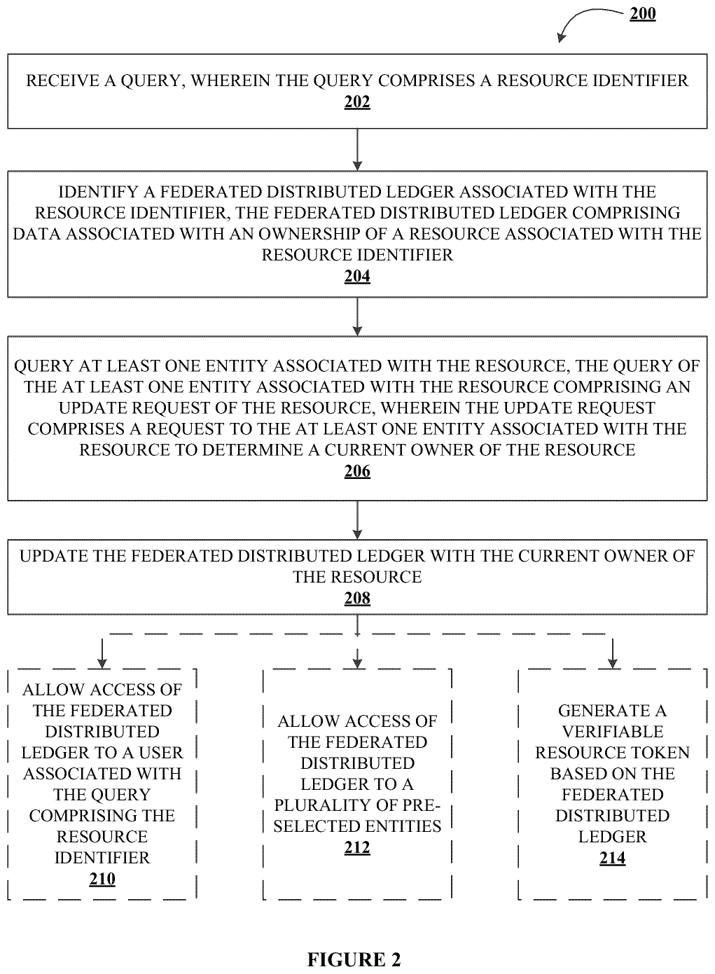

FIG. 2 illustrates a process flow 200 for implementing resource ownership verifications in a federated distributed ledger in a distributed network, in accordance with an embodiment of the invention. In some embodiments, a system (e.g., similar to one or more of the systems described herein with respect to FIGS. 1A-1C) may perform one or more of the steps of process flow 200. For example, an ownership verification system (e.g., the system 130 described herein with respect to FIGS. 1A-1C) may perform the steps of process flow 200.

As shown in block 202, the process flow 200 may include the step of receiving a query, wherein the query comprises a resource identifier. In some embodiments, the ownership verification system may receive the query from a user associated with the resource (e.g., a current owner of the resource), where the user may input a resource identifier of the resource into a user device comprising a graphical user interface configured by the ownership verification system. In some embodiments, the resource identifier may be transmitted from the user device, which was configured by the ownership verification system, to the ownership verification system for identification of a federated distributed ledger comprising the resource identifier.

In some embodiments, the query may be generated by a user—such as an entity separate from the current owner of the resource—that may wish to verify the current owner of the resource based on an alleged current owner disclosing that they are the current owner. For instance, and where an alleged current owner wishes to do business with the entity, an alleged current owner may identify a resource to the entity that the alleged current owner may have ownership rights in (e.g., such as where the alleged current owner wishes to prove the alleged current owner has ownership rights in a house, a piece of property, and/or the like and may want to leverage that ownership to enter into business with the entity). In some embodiments, the entity may wish to verify the ownership of the resource before moving forward with the alleged current owner.

In some embodiments, the query may be generated by a user—such as a government entity separate from the current owner of the resource—that may wish to verify the current owner of the resource and the validity of the resource. By way of non-limiting example, and where the resource is an identification certificate/card, a passport, a birth certificate, a social security number, and/or the like, the entity may wish to query the ownership verification system with the resource identifier to confirm whether the alleged current owner submitting the government certificate is in fact the current owner. In some embodiments, the ownership verification system may also, in the process of determining the current owner, determine whether the resource is valid. By way of non-limiting example, and where an alleged current owner presents a resource and/or resource identifier to the entity and alleges an ownership, the entity may determine that the alleged current owner has misappropriated the resource and/or resource identifier and may transmit a signal to the ownership verification system that the resource and/or resource identifier is no longer secure. In some embodiments, the ownership verification system may then transmit an indication to the current owner of the resource informing the current owner that the resource and/or resource identifier has been misappropriated.

As shown in block 204, the process flow 200 may include the step of identifying a federated distributed ledger associated with the resource identifier, the federated distributed ledger comprising data associated with an ownership of a resource. By way of non-limiting example, the ownership verification system may identify a federated distributed ledger associated with a resource based on the resource identifier of the resource. In some embodiments, the resource identifier of the resource may be stored within the federated distributed ledger, such that each federated distributed ledger is associated with a single resource. For instance, the federated distributed ledger may comprise the data regarding the resource such as data associated with the resource's owner, associated entities of the resource (e.g., a financial institution that issued the resource), associated changes in the resource (e.g., payments made to the principal amount associated with the resource where the resource is a mortgage certificate), associated geolocations of the resource (e.g., where the resource is a passport), and/or the like.

In some embodiments, the identification of the federated distributed ledger comprises querying a plurality of federated distributed ledgers for the resource identifier. By way of non-limiting example, the ownership verification system may identify and/or determine a single federated distributed ledger stored within a decentralized database comprising a plurality of distributed ledgers associated with a plurality of resource identifiers, where the ownership verification system may query each distributed ledger for the resource identifier until the ownership verification system can identify at least one federated distributed ledger comprising the resource identifier.

In some embodiments, the federated distributed ledger comprising the resource identifier may further comprise all or a partial amount of historical data of the resource. For instance, and in some embodiments, the historical data of the resource may comprise the historical ownership of the resource which may further include owner identifiers of each owner the resource previously and currently belongs to. In some embodiments, each owner identifier may further be associated with a plurality of timestamps, which may be stored in the federated distributed ledger associated with the resource, where the plurality of timestamps may indicate times in which an ownership may have changed for the resource. For instance, and where the ownership may change for the resource, a timestamp may be recorded on the federated distributed ledger to show at what time ownership changed and may further comprise an association of a previous owner identifier and a new owner identifier. In some embodiments, the ownership verification system may track the historical data of the resource, including but not limited to the historical data regarding the geolocations associated with the resource (e.g., where the resource is a passport, the federated distributed ledger may comprise each geolocation the passport was used), historical data regarding the payments made that are associated with the resource (e.g., where the resource is a mortgage certificate, the federated distributed ledger may comprise the payments made toward the principal amount of the mortgage), the historical data regarding the timestamps of each payment made that are associated with the resource, and/or the like.

In some embodiments, the resource may be at least one of a government identification certificate, an owner certificate, and/or the like. In some embodiments, the resource may be a government identification certificate, where the government identification certificate may have been generated and/or issued by a government entity, such as a passport, a driver's license, an identification card, a birth certificates, a social security number, and/or the like. In some embodiments, the resource may be an owner certificate, where the owner certificate may have been generated and/or issued in order to show an ownership of a real-world resource such as a certificate showing ownership of real estate (e.g., a mortgage certificate, a title certificate, and/or the like). In some embodiments, the owner certificate may have been generated and/or issued by a financial institution.

In some embodiments, the federate distributed ledger may comprise data regarding a plurality of geolocations associated with the resource. For instance, a geolocation associated with the resource may comprise the geolocation of a piece of property identified by an owner certificate, such as the geolocation of a house and/or land where the owner certificate is a mortgage certificate. In some embodiments, the geolocation associated with the resource may comprise a plurality of geolocations, such as a plurality of geolocations where the resource may be a passport and the plurality of geolocations may comprise geolocations the passport has been used.

In some embodiments, the federated distributed ledger may comprise data regarding a plurality of timestamps associated with the resource. For instance, the resource may be associated with a plurality of timestamps based on the resource being used and/or updated at times captured by the timestamps. By way of non-limiting example, and where the resource is a passport, a timestamp may be recorded at each time the passport is used at a geolocation and each timestamp of the plurality of timestamps may be associated (e.g., recorded) with the respective geolocation. In some embodiments, and by way of non-limiting example, where the resource is a government identification certificate (e.g., a driver's license/ID, a birth certificate, and/or the like), the ownership verification system may record a timestamp to be associated with the resource when the resource is issued (e.g., a driver's license is issued, a birth certificate or copy of a birth certificate is issued, a passport is issued, a social security number is issued, and/or the like); when the resource is used (e.g., a driver's license is scanned or the details are input into a search query, a birth certificate is scanned or the details are input into a query, a passport is scanned or the details are input into a query, and/or the like); and/or the like.

In some embodiments, and where the resource is an owner certificate, the ownership verification system may record timestamps where the resource is updated with new data. For instance, new data may comprise new data regarding ownership of the resource and/or of the property associated with the resource (e.g., where the resource is a mortgage certificate and the property associated with the resource is a house or piece of land), new data regarding the payment required for ownership of a property associated with the resource (e.g., where a payment has been made toward a mortgage), new data regarding parties associated with the resource (e.g., such as an entity that is associated with the owner certificate like a financial institution that generated the owner certificate), and/or the like.

As shown in block 206, the process flow 200 may include the step of querying at least one entity associated with the resource, the query of the at least one entity associated with the resource comprising an update request of the resource. In some embodiments, the update request may comprise a request to the at least one entity associated with the resource to determine a current owner of the resource. By way of non-limiting example, the ownership verification system may query and/or submit a request to an entity associated with the resource to request an update of the resource data to the federated distributed ledger. For instance, the update of the resource data may comprise any data stored in the federated distributed ledger, such as but not limited to timestamps, historical data (e.g., ownership data, payment data, geolocation data, and/or the like), and/or the like.

The update request of the resource may be indicated by the ownership verification system through the transmission of the update request to an entity associated with the resource, such as a financial institution associated with the resource or a government entity associated with the resource. For instance, and in some embodiments, the ownership verification system may transmit the update request to the entity and the entity, in turn, may search through its database(s) to identify the resource identifier associated with the update request and the associated historical data of the resource. In some embodiments, the historical data may comprise the previous owner(s) of the resource (e.g., owner identifier(s)), the current owner of the resource (e.g., owner identifier), timestamps of changes in ownership, geolocation data, and/or the like.

As shown in block 208, the process flow 200 may include the step of updating the federated distributed ledger with the current owner of the resource. By way of non-limiting example, the ownership verification system may update the federated distributed ledger with the received historical data by adding and/or updating entries to the federated distributed ledger to comprise received historical data.

In some embodiments, and upon the entity identifying the resource within its database(s) and the associated historical data, the entity may transmit at least one of the previous owner identifier(s), the current owner identifier(s), the timestamp data, the geolocation data, and/or the like, to the ownership verification system. Such a transmission may occur over a network, such as network 110. In some embodiments, and upon receiving at least one of a type of historical data from the entity associated with the resource, the ownership verification system may update the federated distributed ledger to comprise the historical data for the resource such that any data not previously recorded on the federated distributed ledger may be added to the federated distributed ledger on a new entry, such as a new block within the federated distributed ledger. In some embodiments, the ownership verification system may update the federated distributed ledger to be a complete recitation of historical data received from the entity associated with the resource, including but not limited to each iteration of historical data received by the ownership verification system, including duplicate data.

In some embodiments, the ownership verification system may record each entry to the federated distributed ledger comprising the received historical data with a separate timestamp (i.e., a received data timestamp), where the received data timestamp may indicate when the historical data was received which was used to update the federated distributed ledger. In some embodiments, the ownership verification system may record each entry to the federated distributed ledger with a block timestamp, where each entry and/or block within the federated distributed ledger may comprise and/or be associated with its own timestamp indicating when the new entry and/or block was generated in the federated distributed ledger.

In some embodiments, and as shown in block 210, the process flow 200 may include the step of allowing access of the federated distributed ledger to a user associated with the query comprising the resource identifier. By way of non-limiting example, the ownership verification system may allow access of the federated distributed ledger to a user where the user originally submitted the query comprising the resource identifier that the ownership verification system used to identify the federated distributed ledger. By way of non-limiting example, a user who is not associated with the resource, such as an entity that submitted the query to the ownership verification system to identify the federated distributed ledger and the current owner of the resource, may be allowed access to the federated distributed ledger for authentication. For instance, and where the user is an entity the current owner is attempting to prove ownership to, the ownership verification system may authenticate the entity as a trusted entity that can access the federated distributed ledger in a limited circumstance. In some embodiments, the limited circumstance may comprise a limited time period (e.g., a 24-hour period, a 12-hour period, a 6-hour period, a 1-hour period, a 30-minute period, and/or the like), a limited geolocation (e.g., the entity may only access the federated distributed ledger where the entity previously submitted the query, such as the entity's office which the current owner may have visited, and/or the like), a limited device (e.g., the entity may only access the federated distributed ledger from the device the query was originally transmitted from), and/or the like.

In some embodiments, the ownership verification system may allow access to the federated distributed ledger based on an identification of a user through authentication credentials, such as where a user logs into the ownership verification system and identifies themselves to the ownership verification system. In some embodiments—and based on the authentication credentials and the user account identifier associated with the authentication credentials—the ownership verification system may allow the user to access the federated distributed ledger. For instance, and where the authentication credentials are used to identify the user account identifier as the current owner of the resource, the ownership verification system may allow access of the user to the federated distributed ledger.

In some embodiments, and as shown in block 212, the process flow 200 may include the step of allowing access of the federated distributed ledger to a plurality of pre-selected entities. In some embodiments, the ownership verification system may allow access of the federated distributed ledger to a plurality of entities, which may comprise at least one of a preselection by the current owner of the resource, a preselection by an entity associated with the resource, a preselection by the ownership verification system, and/or the like.

By way of non-limiting example, and in some embodiments, an entity preselected by the current owner may comprise the current owner submitting and/or transmitting a plurality of entity identifiers to the ownership verification system comprising entities the current owner may wish to have access to the federated distributed ledger associated with the resource the current owner owns. In some embodiments, these entity identifiers may be generated based on the current owner's associated entities (e.g., entities the current owner trusts and is in contact with), such as financial institutions the current owner is associated with, government entities the current owner is associated with, companies the current owner does business with, individual users the current owner trusts, and/or the like.

By way of non-limiting example, and in some embodiments, an entity preselected by an entity associated with the resource may comprise a selection by the financial institution that generated and/or issued the resource (e.g., such as the financial institution that generated the mortgage certificate, title certificate, and/or the like), the government entity who generated and/or issued the resource (e.g., such as the government that generated the passport, identification card, birth certificate, social security number, and/or the like), and/or the like. In some embodiments, the ownership verification system may receive a plurality of entity identifiers from the entity associated with the resource, where the plurality of entity identifiers may be associated with other trusted entities, such as other financial institutions, other government entities, and/or the like. In this manner, the ownership verification system may allow access to the federated distributed ledger to these preselected entities to allow stream-lined access of the trusted entities without the current owner's intervention, such as where the resource's ownership must be verified quickly and efficiently. For instance, and where the resource is a passport, the trusted entity(ies) may need to quickly verify ownership of the passport by accessing the federated distributed ledger without needing prior authorization by the current owner. Such an embodiment may mitigate the threat of misappropriation of the resource. Likewise, trusted entities that may be financial institutions may easily and efficiently verify ownership of the resource where a user attempts to allege that the user owns the resource, without needing prior authorization from the current owner to access the federated distributed ledger.

By way of non-limiting example, and in some embodiments, an entity pre-selected by the ownership verification system may comprise a selection by the ownership verification system of trusted entities, such as a plurality of financial institutions, a plurality of government entities, and/or the like, where a manager of the ownership verification system may determine the trustworthiness of each entity. In some embodiments, the trustworthiness of the entities may be determined by the ownership verification system based on other federated distributed ledgers and their associated preselected entities.

In some embodiments, and as shown in block 214, the process flow 200 may include the step of generating a verifiable resource token based on the federated distributed ledger. By way of non-limiting example, the ownership verification system may generate a verifiable resource token, such as a non-fungible token, that can be used by the current owner of the resource to indicate the current owner's verified ownership of the resource. For instance, such a verifiable resource token may be a digital certificate of verified ownership of the resource that the current owner may “carry” with them, such as within a digital wallet, a digital locker, and/or the like.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for implementing a resource ownership verification, the system comprising:
a memory device with computer-readable program code stored thereon;
at least one processing device operatively coupled to the at least one memory device and the at least one communication device, wherein executing the computer-readable code is configured to cause the at least one processing device to:
receive a query, wherein the query comprises a resource identifier;
identify a federated distributed ledger associated with the resource identifier, the federated distributed ledger comprising data associated with an ownership of a resource associated with the resource identifier;
query at least one entity associated with the resource, the query of the at least one entity associated with the resource comprising an update request of the resource,
wherein the update request comprises a request to the at least one entity associated with the resource to determine a current owner of the resource; and
update the federated distributed ledger with the current owner of the resource.

2. The system of claim 1, wherein the processing device is further configured to allow access of the federated distributed ledger to a user associated with the query comprising the resource identifier.

3. The system of claim 1, wherein the processing device is further configured to allow access of the federated distributed ledger to a plurality of pre-selected entities.

4. The system of claim 1, wherein the processing device is further configured to generate a verifiable resource token based on the federated distributed ledger, wherein the verifiable resource token comprises data of at least the resource and the current owner of the resource.

5. The system of claim 1, wherein the identification of the federated distributed ledger comprises querying a plurality of federated distributed ledgers based on the resource identifier.

6. The system of claim 1, wherein the federated distributed ledger associated with the resource comprises data regarding a historical ownership of the resource.

7. The system of claim 1, wherein the resource is at least one of a government identification certificate or an owner certificate.

8. The system of claim 1, wherein the federated distributed ledger comprises data regarding a plurality of geolocations associated with the resource.

9. The system of claim 1, wherein the federated distributed ledger comprises data regarding a plurality of timestamps associated with the resource.

10. A computer program product for implementing a resource ownership verification, wherein the computer program product comprises at least one non-transitory computer-readable medium having computer-readable program code portions embodied therein, the computer-readable program code portions which when executed by a processing device are configured to cause the processor to:
receive a query, wherein the query comprises a resource identifier;
identify a federated distributed ledger associated with the resource identifier, the federated distributed ledger comprising data associated with an ownership of a resource associated with the resource identifier;
query at least one entity associated with the resource, the query of the at least one entity associated with the resource comprising an update request of the resource,
wherein the update request comprises a request to the at least one entity associated with the resource to determine a current owner of the resource; and
update the federated distributed ledger with the current owner of the resource.

11. The computer program product of claim 10, wherein the processing device processing device is further configured to cause the processor to generate a verifiable resource token based on the federated distributed ledger, wherein the verifiable resource token comprises data of at least the resource and the current owner of the resource.

12. The computer program product of claim 10, wherein the identification of the federated distributed ledger comprises querying a plurality of federated distributed ledgers based on the resource identifier.

13. The computer program product of claim 10, wherein the federated distributed ledger associated with the resource comprises data regarding a historical ownership of the resource.

14. The computer program product of claim 10, wherein the federated distributed ledger comprises data regarding a plurality of geolocations associated with the resource.

15. The computer program product of claim 10, wherein the federated distributed ledger comprises data regarding a plurality of timestamps associated with the resource.

16. A computer-implemented method for implementing a resource ownership verification, the computer-implemented method comprising:
receiving a query, wherein the query comprises a resource identifier;
identifying a federated distributed ledger associated with the resource identifier, the federated distributed ledger comprising data associated with an ownership of a resource associated with the resource identifier;
querying at least one entity associated with the resource, the query of the at least one entity associated with the resource comprising an update request of the resource,
wherein the update request comprises a request to the at least one entity associated with the resource to determine a current owner of the resource; and
updating the federated distributed ledger with the current owner of the resource.

17. The computer-implemented method of claim 16, the computer-implemented method further comprising generating a verifiable resource token based on the federated distributed ledger, wherein the verifiable resource token comprises data of at least the resource and the current owner of the resource.

18. The computer-implemented method of claim 16, wherein the identification of the federated distributed ledger comprises querying a plurality of federated distributed ledgers based on the resource identifier.

19. The computer-implemented method of claim 16, wherein the federated distributed ledger comprises data regarding a plurality of geolocations associated with the resource.

20. The computer-implemented method of claim 16, wherein the federated distributed ledger comprises data regarding a plurality of timestamps associated with the resource.
